(19) United States
(12) Patent Application Publication
(10) Pub. No.: US 2002/0074187 A1
(43) Pub. Date: Jun. 20, 2002

(54) Stabilizers for a step ladder and a step ladder equipped with stabilizers

(76) Inventors: Fred Albert Bendle, St. Albert (CA); Trevor Frederick Bendle, St. Albert (CA)

Correspondence Address: DAVIS & BUJOLD, P.L.L.C., 500 NORTH COMMERCIAL STREET, FOURTH FLOOR, MANCHESTER, NH, 03101, US

(21) Appl. No.: 10/047,904

(22) Filed: Jan. 14, 2002

(30) Foreign Application Priority Data
Feb. 15, 2000 (CA) 2,298,896

(51) Int. Cl. E06C 1/00

(52) U.S. Cl. 182/172

(57) ABSTRACT

Stabilizers for a step ladder and a step ladder with such stabilizers. The stabilizers consist of a pair of lateral supports. Each of the lateral supports has a first end and a second end. The first end is mounted to a top end of one of opposed side rails of the ladder. The mounting swivels to adjust the positioning of the lateral support about a plane perpendicular to a second plane lying across the side rails. The mounting also includes a pivot joint enabling movement between a stored positioned parallel to one of the side rails and an operative position in which the lateral support extends outwardly and downwardly with the second end of the lateral support spaced laterally from the side rails and swivelled into an intermediate position between the side rail and the support frame.

### FIELD OF THE INVENTION

The present invention relates to a stabilizer for a step ladder and a step ladder equipped with a stabilizer

### BACKGROUND OF THE INVENTION

A number of ladder stabilizing devices have been developed for use with extension ladders. An example of such a stabilizing device is U.S. Pat. No. 5,868,222 which issued to Carbonneau in 1999. The Carbonneau stabilizing device consists of two stabilizing supports that extend outwardly and downwardly from the side rails of an extension ladder on a common plane with the extension ladder. When the stabilizing supports are in an operative position, braces are positioned between the stabilizing supports and the side rails of the extension ladder.

These stabilizing devices are not able to stabilize a step ladder. The higher a person climbs up the rungs of a step ladder, the more an over balanced condition is created. If care is not taken, this over balanced condition can result in the ladder tipping.

### SUMMARY OF THE INVENTION

What is required is a stabilizing device that can be used with a step ladder.

According to one aspect of the present invention there is provided a stabilizer for a step ladder which includes a pair of lateral supports. Each of the lateral supports has a first end and a second end. A mounting is provided at the first end which is adapted for mounting the lateral support to a top end of a side rail of a step ladder. The mounting includes a pivot joint adapted-to enable movement between a stored positioned parallel to the side rail and an operative position in which the lateral support extends outwardly and downwardly with the second end of the lateral support spaced laterally from the side rail. The mounting is also adapted to swivel into an intermediate position between the side rail and the support frame when in the operative position. Means is provided for maintaining the lateral support in the operative position.

According to another aspect of the present invention there is provided a step ladder with stabilizer which includes a body having a first side rail and a second side rail in parallel spaced relation. A plurality of steps extend between the first side rail and the second side rail. The body has a top end and a bottom end. A support frame is provided having a first end and a second end. The first end is pivotally mounted to the top end of the body for movement between a stored position parallel to the body and an operative position in which the second end of the support frame is spaced from the body. Means is provided for limiting the pivotal movement of the support frame relative to the body in the operative position. A first lateral support is provided having a first end and a second end. The first end is mounted to the top end of the first side rail by a first mounting. The first mounting swivels to adjust the positioning of the lateral support about a first plane perpendicular to a second plane lying across the first side rail and the second side rail. The first mounting includes a pivot joint enabling movement between a stored positioned parallel to the first side rail and an operative position in which the first lateral support extends outwardly and downwardly with the second end of the first lateral support spaced laterally from the first side rail and swivelled into an intermediate position between the first side rail and the support frame. Means is provided for maintaining the first lateral support in the operative position. A second lateral support is provided having a first end and a second end. The first end is mounted to the top end of the second side rail by a second mounting. The second mounting swivels to adjust the positioning of the lateral support about a third plane perpendicular to the second plane lying across the first side rail and the second side rail. The second mounting includes a pivot joint enabling movement between a stored positioned parallel to the second side rail and an operative position in which the second lateral support extends outwardly and downwardly with the second end of the second lateral support spaced laterally from the second side rail and swivelled into an intermediate position between the second side rail and the support frame. Means is provided for maintaining the second lateral support in the operative position.

The first lateral support and the second lateral support, on the step ladder with stabilizer described above, can be swivelled into a position intermediate the body and the support frame, where the stabilizing support is needed. The first lateral support and the second lateral support can then be pivoted outwardly into a stable stance. Once in the operative supporting position, the first lateral support and the second lateral support are fixed against movement. The preferred means of securing the lateral support being with braces.

### BRIEF DESCRIPTION OF THE DRAWINGS

These and other features of the invention will become more apparent from the following description in which reference is made to the appended drawings, wherein:

FIG. 1 is a perspective view of a step ladder with stabilizers constructed in accordance with the teachings of the present invention.

FIG. 2 is a side elevation view of the step ladder with stabilizers illustrated in FIG. 1, with stabilizers in an operative position.

FIG. 3 is a front elevation view of the step ladder with stabilizers illustrated in FIG. 1, with stabilizers in an operative position.

FIG. 4 is a side elevation view of the step ladder with stabilizers illustrated in FIG. 1, with stabilizers in a stored position.

FIG. 5 is a front elevation view of the step ladder with stabilizers illustrated in FIG. 1, with stabilizers in a stored position.

FIG. 6 is a detailed side elevation view of the braces for the step ladder with stabilizers illustrated in FIG. 1.

FIG. 7 is a detailed perspective view of the detachable ends of the braces for the step ladder with stabilizers illustrated in FIG. 1.

FIG. 8 is a detailed side elevation view, in section, of the braces for the step ladder with stabilizers illustrated in FIG. 1.

### DETAILED DESCRIPTION OF THE PREFERRED EMBODIMENT

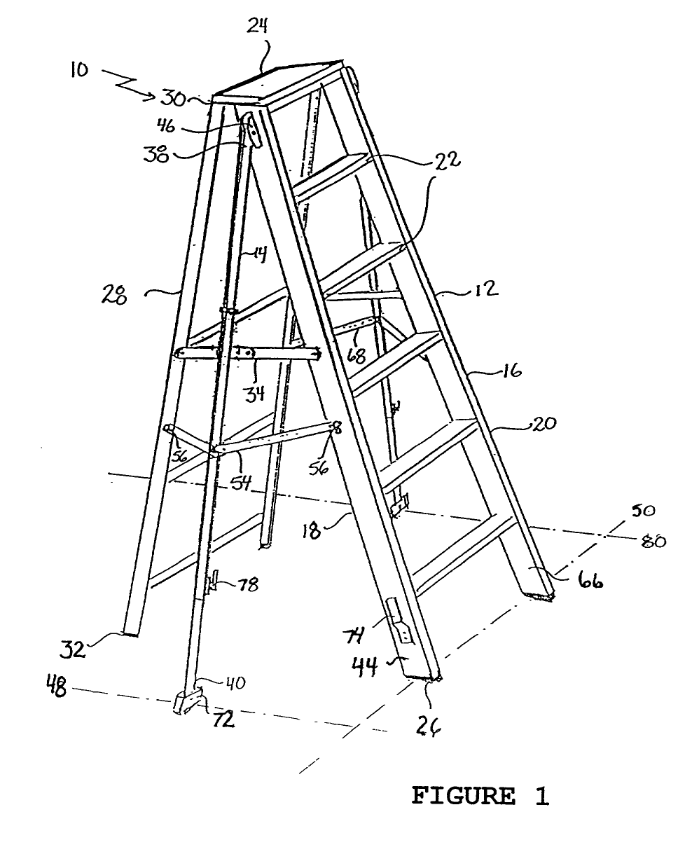

The preferred embodiment, a step ladder with stabilizers generally identified by reference numeral 10, will now be described with reference to FIGS. 1 through 5.

Referring to FIG. 1, step ladder with stabilizers 10 consists of a step ladder 12 and stabilizer 14. Step ladder 12 includes a body 16 that has a first side rail 18 and a second side rail 20 in parallel spaced relation with a plurality of steps 22 extending between first side rail 18 and second side rail 20. Body 16 has a top end 24 and a bottom end 26.

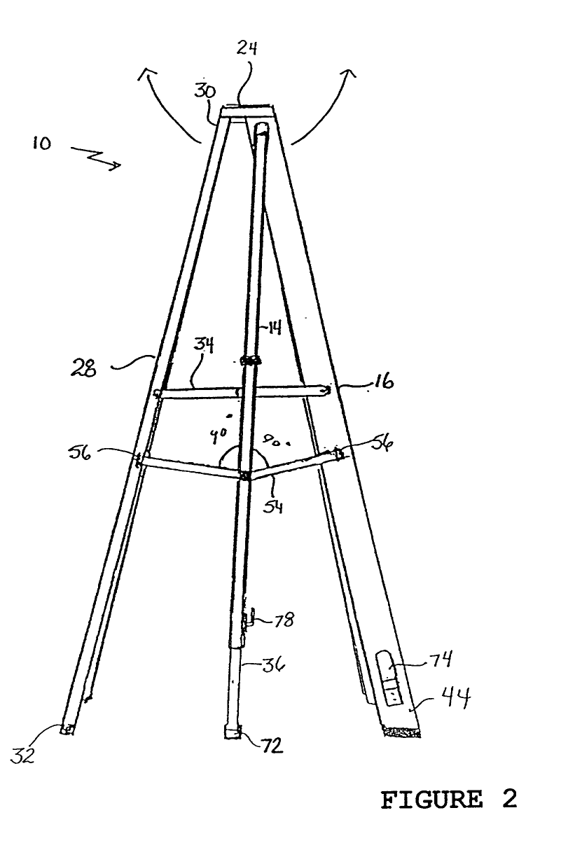

Referring to FIG. 2, there is illustrated a support frame 28 which has a first end 30 and a second end 32. First end 30 is pivotally mounted to top end 24 of body 16 for movement between a stored position parallel to body 16 and an operative position in which second end 32 of support frame 28 is spaced from the body 16. A two piece locking brace 34 provided for limiting the pivotal movement of support frame 28 relative to body 16 in the operative position;

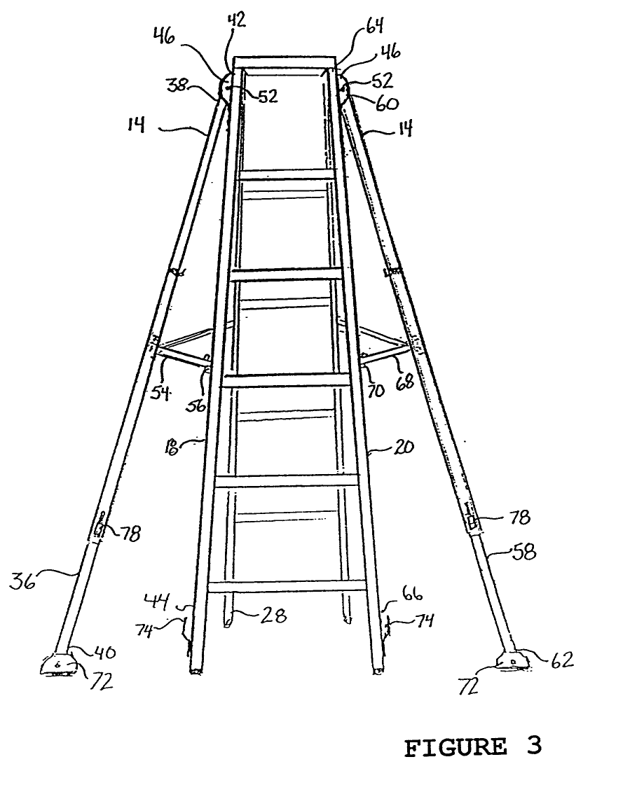

Referring to FIGS. 1 and 3 stabilizers 14 include a first extendible lateral support 36 that has a first end 38 and a second end 40. First end 38 is mounted to the top end 42 of first side rail 18 by a mounting 46. Mounting 46 swivels to adjust the positioning of lateral support 36 about a first plane 48 perpendicular to a second plane 50 that lies across first side rail 18 and second side rail 20. Mounting 46 includes a pivot joint 52 that enables movement between a stored positioned parallel to first side rail 18 and an operative position in which first lateral support 36 extends outwardly and downwardly. In the operative position, second end 40 of first lateral support 36 is spaced laterally from first side rail 18 and is swivelled into an intermediate position between first side rail 18 and support frame 28.

Referring to FIGS. 2 and 3, a first pair of braces 54 extends from each of first side rail 18 and support frame 28 to first lateral support 36 so that first lateral support 36 is maintained in the operative position. Each of first pair of braces 54 has a detachable end 56, whereby detachable end 56 is detached so as to permit first lateral support 36 to assume the stored position. A second extendible lateral support 58 has a first end 60 and a second end 62. First end 60 is mounted to top end 64 of second side rail 20 by a mounting 46. Mounting 46 swivels to adjust the positioning of second lateral support 58 about a third plane 80 perpendicular to second plane 50 lying across first side rail 18 and second side rail 20. Mounting 46 includes a pivot joint 52 that enables movement between a stored position parallel to second side rail 20 and an operative position in which second lateral support 58 extends outwardly and downwardly with second end 62 of second lateral support 58 spaced laterally from second side rail 20 and swivelled into an intermediate position between second side rail 20 and the support frame 28. A second pair of braces 68 extend from each of second side rail 20 and support frame 28 to second lateral support 58 whereby second lateral support 58 is maintained in the operative position. Each of second pair of braces 68 has a detachable end 70, whereby detachable end 70 is detached in order to permit second lateral support 58 to assume the stored position.

A pivoting foot 72 is positioned at second end 40 of first lateral support 36 which can pivot to engage a catch 74 which positioned at second end 44 of first side rail when step ladder with stabilizers 10 is placed in the stored position. Pivoting foot 72 is also positioned at second end of second lateral support 58 which engages catch 74 positioned at second end 66 of second side rail 20 when step ladder with stabilizers 10 is placed in the stored position. Stabilizers 14 each have a locking lever 78 which locks to hold first lateral support 36 and second lateral support in place after being adjusted for lateral positioning.

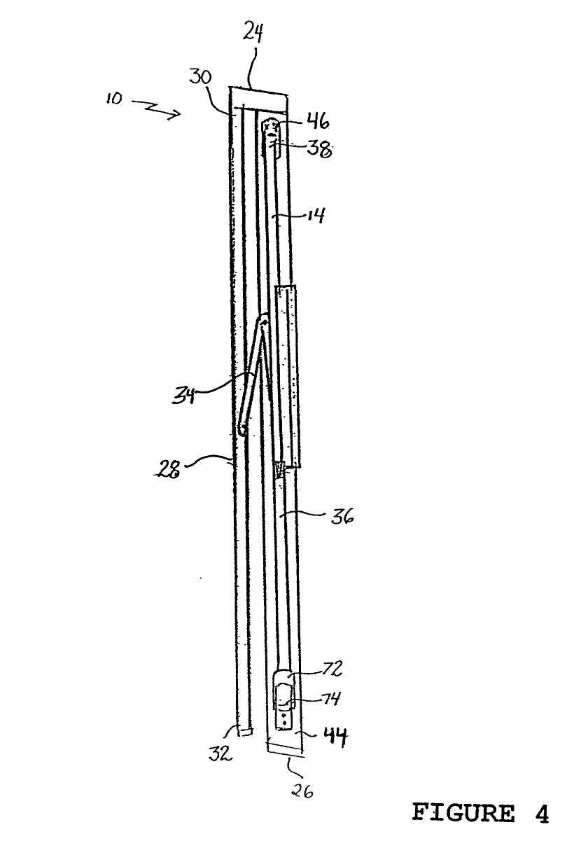

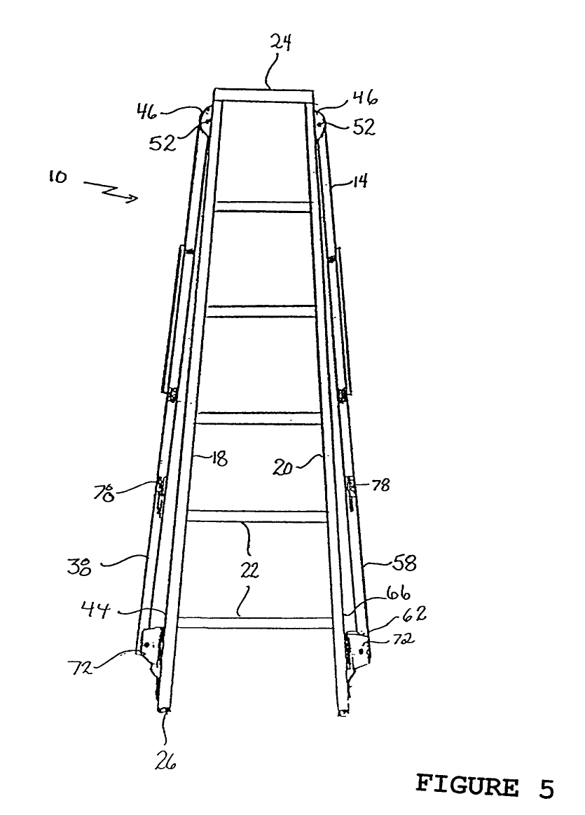

The manner of use of step ladder with stabilizers 10 will now be described with reference to FIGS. 1 through 5. Referring to FIG. 4 and 5, step ladder with stabilizers 10 is stored in the stored position. When step ladder with stabilizers 10 is required to be used, step ladder with stabilizers 14 is transported to the site of use in the stored position. Referring to FIGS. 1, 2, and 3, at the site of use, step ladder with stabilizers 10 must be placed in the operative position. To place step ladder with stabilizers 10 in the operative position, stabilizers 14 are disengaged from first side rail 18 and second side rail 20 by unhooking pivoting feet 72 from catches 74. Support frame 28 is pivotally spaced from body 16 with second end of support frame 28 and bottom end 26 of body 16. Locking braces 34 are pushed down so as to limit the pivotal movement of support frame 28 relative to body 16. Stabilizers 14 swivel into position about a first plane 48 perpendicular to a second plane 50 that lies across first side rail 18 and second side rail 20, and are placed in an intermediate positioned between body 16 of step ladder 12 and support frame 28. The length of stabilizers 14 are adjusted by unlocking locking lever 78 and moving first lateral support 36 and second lateral support 58 upwards or downward until a suitable length is determined. Locking lever 78 is then engaged so as to lock first lateral support 36 and second lateral support 58 at the determined length. This allows for first lateral support 36 and second lateral support 58 to be locked at different lengths so as to provide better support in the event step ladder with stabilizer 10 is set up in the operative position on an uneven ground. When stabilizers 14 are in position, first lateral support 36 has a first pair of braces 54 which must be attached to first lateral support 36 to maintain the operative position. Similarly, second lateral support 58 has a second pair of braces 68 which must be attached to second lateral support 58 to maintain the operative position. Pivoting feet 72 pivot so to engage the ground. Step ladder with stabilizers 10 is now in the operative position.

When no longer needed, step ladder with stabilizers 10 may be again placed in the stored position for transportation or storage. Referring to FIGS. 4 and 5, to place step ladder with stabilizers 10 in the stored position, detachable end 56 of first pair of braces 54 is detached to allow first lateral support 36 to assume the stored position. Detachable end 70 of second pair of detachable braces 68 is also detached so as to allow second lateral support 58 to assume the stored position. Locking lever maybe unlocked so as to allow for adjustment of the length of stabilizers 14. First lateral support 36 and second lateral support 58 are pivoted to a position parallel with first side rail 18 and second side rail 20, respectively. Pivoting feet 72 are pivoted so as to engage catch 74 thereby holding first lateral support 36 and second lateral support 58 in the stored position. Brace 34 is pushed upwards so as allow support frame 28 to pivot into a position parallel to body 16. Step ladder with stabilizers 10 will now be in the stored position suitable for transportation and storage.

Best Mode:

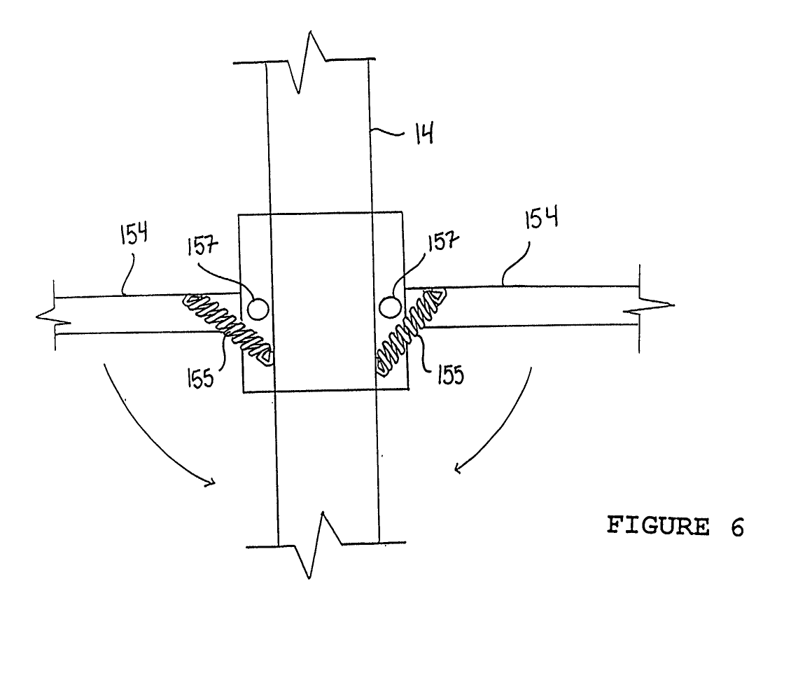

As a result of use of proto-types of stabilizers 10, refinements have been made which will hereinafter be described with reference to FIGS. 6 through 8.

After experimenting with different means for fastening mounting 46 of stabilizers 14 to ladder 12, two sided adhesive tape is preferred. A suitable line of high performance two sided adhesive tape is sold by 3M. One of the reasons adhesive tape is preferred is that, it was discovered that drilling holes and using any form of fastener voided the warranties issued by ladder manufacturers. The reason given for the voiding of the warranties is that the safety certification of the ladders for structural integrity under loading was dependent upon the ladder not being modified.

FIGS. 4 and 5, illustrate step ladder 12 with stabilizers 14 in the stored position. It was discovered that first pair of braces 54 and second pair of braces 68 were not maintaining the stored position, when ladder 12 was tilted during transport. Referring to FIG. 6, there is illustrated a modified form of brace 154. The modification merely consisted in placing biasing springs 155 at pivotal connection 157, so that braces 154 were biased by springs 155 to the stored position illustrated in FIGS. 4 and 5.

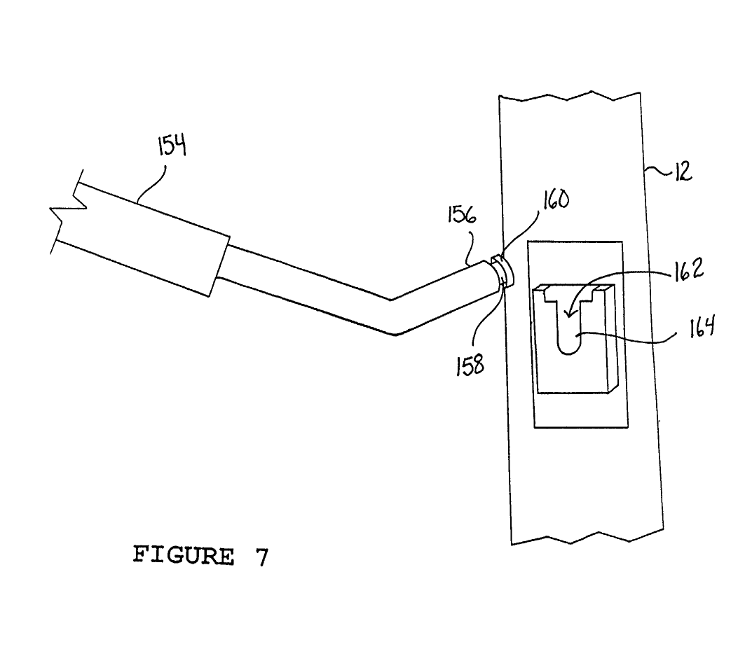

Referring to FIG. 3, each of first pair of braces 54 had detachable ends 56 and each of second pair of braces 68 had a detachable ends 70. After experimenting with different forms of detachable ends, a preferred form of detachable end was determined. Referring to FIG. 7, there is illustrated a modified form of brace 154. Brace 154 has a detachable end 156 with a projecting pin 158 that supports a cantilevered engagement member 160. Cantilevered engagement member 160 is received in a pocket 162 mounted on ladder 12. Pocket 162 has a vertical slot 164 to accommodate projecting pin 158. The above described engagement served as a quick connect type of engagement while still providing the desired degree of stability and load bearing capacity.

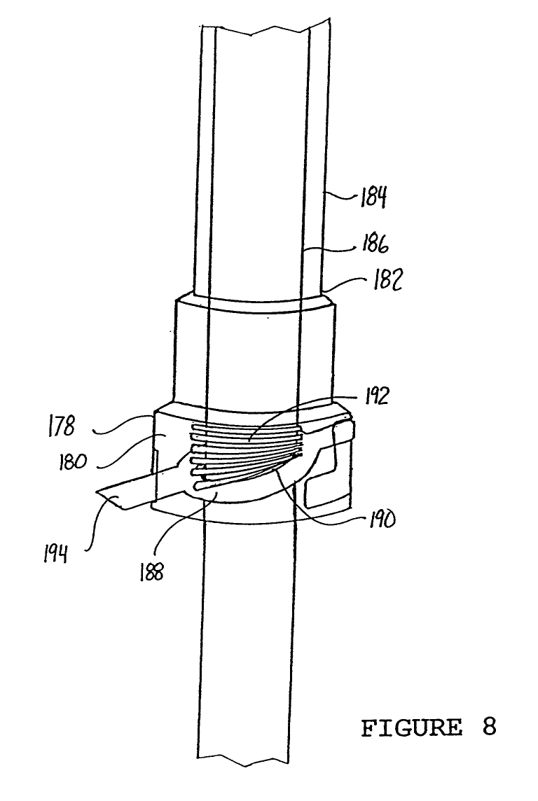

Referring to FIG. 3, both first lateral support 36 and second lateral support 58 have locking lever 78 which serves lock them in a selected telescopically extended position. Different forms of locking levers were tried in an attempt to find one that permitted quick adjustment along with the ability to maintain its position without slippage when under load. Referring to FIG. 8, there is illustrated a preferred form of locking lever 178. Locking lever 178 includes a housing 180 which is positioned on a remote end 182 of a first telescopic member 184. A second telescopic member 186 is telescopically received within first telescopic member 184. A pressure member 188 is pivotally mounted within housing 180. Pressure member 188 has a central opening 190 through which second telescopic member 186 extends. Pressure member 188 is pivotally movable between a locking position bearing against second telescopic member 186 and a release position in which second telescopic member 186 is able to slide freely through central opening 190. A biasing spring 192 is provided which bears against housing 180 and against pressure member 188 to force pressure member 188 into the locking position. A finger grip 194 is provided which protrudes from housing 180 and is used to manually move pressure member 188 to the release position.

It will be apparent to one skilled in the art that modifications may be made to the illustrated embodiment without departing from the spirit and scope of the invention as hereinafter defined in the claims.

The embodiments of the invention in which an exclusive property or privilege is claimed are defined as follows:

1. A stabilizer for a step ladder, comprising:
a pair of lateral supports, each having:
a first end and a second end;
a mounting at the first end adapted for mounting the lateral support to a top end of a side rail of a step ladder, the mounting including a pivot joint adapted to enable movement between a stored positioned parallel to the side rail and an operative position in which the lateral support extends outwardly and downwardly with the second end of the lateral support spaced laterally from the side rail, the mounting being also adapted to swivel into an intermediate position between the side rail and the support frame when in the operative position; and
means for maintaining the lateral support in the operative position.

2. The stabilizer for a step ladder as defined in claim 1, wherein each lateral support is telescopically extendible.

3. The stabilizer for a step ladder as defined in claim 2, wherein each lateral support has a first telescopic member, a second telescopic member telescopically received within the first telescopic member and a locking lever to maintain the first telescopic member and the second telescopic member in a selected telescopic relation, the locking lever including a housing positioned on a remote end of the first telescopic member, a pressure member pivotally mounted within the housing has a central opening through which the second telescopic member extends, the pressure member is pivotally movable between a locking position bearing against the second telescopic member and a release position in which the second telescopic member is able to slide freely through the central opening, a biasing spring bears against housing and against the pressure member to maintain the pressure member in the locking position, a release is provided which protrudes from the housing and is used to manually move the pressure member to the release position.

4. The stabilizer for a step ladder as defined in claim 1, wherein each lateral support has a pair of braces, one brace of the pair of braces adapted for being detachably secured to the side rail of the step ladder and another brace of the pair of braces being detachably secured to a support frame of the step ladder.

5. The stabilizer for a step ladder as defined in claim 4, wherein each pair of braces has biasing springs biasing the braces into a stored position substantially parallel with the lateral support.

6. The stabilizer for a step ladder as defined in claim 4, wherein each brace of each pair of braces has a detachable end with a projecting pin that supports a cantilevered engagement member, the cantilevered engagement member being received in a pocket, the pocket having a vertical slot to accommodate the projecting pin.

7. A stabilizer for a step ladder, comprising:
a pair of telescopically extendible lateral supports, each having:
a first end and a second end;
a first telescopic member, a second telescopic member telescopically received within the first telescopic member and a locking lever to maintain the first telescopic member and the second telescopic member in a selected telescopic relation, the locking lever including a housing positioned on a remote end of the first telescopic member, a pressure member pivotally mounted within the housing has a central opening through which the second telescopic member extends, the pressure member is pivotally movable between a locking position bearing against the second telescopic member and a release position in which the second telescopic member is able to slide freely through the central opening, a biasing spring bears against housing and against the pressure member to maintain the pressure member in the locking position, a release is provided which protrudes from the housing and is used to manually move the pressure member to the release position;
a mounting at the first end adapted for mounting the lateral support to a top end of a side rail of a step ladder, the mounting including a pivot joint adapted to enable movement between a stored positioned parallel to the side rail and an operative position in which the lateral support extends outwardly and downwardly with the second end of the lateral support spaced laterally from the side rail, the mounting being also adapted to swivel into an intermediate position between the side rail and the support frame when in the operative position; and
a pair of braces for maintaining the lateral support in the operative position, one brace of the pair of braces adapted for being detachably secured to the side rail of the step ladder and another brace of the pair of braces adapted for being detachably secured to a support frame of the step ladder, the pair of braces having biasing springs biasing the braces into a stored position substantially parallel to the lateral support, each brace of the pair of braces having a detachable end with a projecting pin that supports a cantilevered engagement member, the cantilevered engagement member being received in a pocket, the pocket having a vertical slot to accommodate the projecting pin.

8. A step ladder with stabilizer, comprising:
a body having a first side rail and a second side rail in parallel spaced relation, a plurality of steps extending between the first side rail and the second side rail, the body having a top end and a bottom end;
a support frame having a first end and a second end, the first end being pivotally mounted to the top end of the body for movement between a stored position parallel to the body and an operative position in which the second end of the support frame is spaced from the body;
a two piece locking brace for limiting the pivotal movement of the support frame relative to the body in the operative position;
a first telescopically extendible lateral support having a first end and a second end, the first end being mounted to the top end of the first side rail by a mounting, the mounting swivelling to adjust the positioning of the lateral support about a first plane perpendicular to a second plane lying across the first side rail and the second side rail, the mounting including a pivot joint enabling movement between a stored positioned parallel to the first side rail and an operative position in which the first lateral support extends outwardly and downwardly with the second end of the first lateral support spaced laterally from the first side rail and is swivelled into an intermediate position between the first side rail and the support frame;
a first pair of braces extending from each of the first side rail and the support frame to the first lateral support, whereby the first lateral support is maintained in the operative-position, each of the first pair of braces having a detachable end, whereby the detachable end is detached in order to permit the first lateral support to assume the stored position;
a second telescopically extendible lateral support having a first end and a second end, the first end being mounted to the top end of the second side rail by a mounting, the mounting swivelling to adjust the positioning of the lateral support about a third plane perpendicular to the second plane lying across the first side rail and the second side rail, the mounting including a pivot joint enabling movement between a stored positioned parallel to the second side rail and an operative position in which the second lateral support extends outwardly and downwardly with the second end of the second lateral support spaced laterally from the second side rail and swivelled into an intermediate position between the second side rail and the support frame; and
a second pair of braces extending from each of the second side rail and the support frame to the second lateral support whereby the second lateral support is maintained in the operative position, each of the second pair of braces having a detachable end, whereby the detachable end is detached in order to permit the second lateral support to assume the stored position.

9. The step ladder as defined in claim 8, wherein each of the first extendible lateral support and the second extendible lateral support has a first telescopic member, a second telescopic member telescopically received within the first telescopic member and a locking lever to maintain the first telescopic member and the second telescopic member in a selected telescopic relation, the locking lever including a housing positioned on a remote end of the first telescopic member, a pressure member pivotally mounted within the housing has a central opening through which the second telescopic member extends, the pressure member is pivotally movable between a locking position bearing against the second telescopic member and a release position in which the second telescopic member is able to slide freely through the central opening, a biasing spring bears against housing and against the pressure member to maintain the pressure member in the locking position, a release is provided which protrudes from the housing and is used to manually move the pressure member to the release position.

10. The step ladder as defined in claim 8, wherein each of the first pair of braces and the second pair of braces has biasing springs biasing the braces into a stored position substantially parallel with one of the first telescopically extendible lateral support and the second telescopically extendible lateral support.

11. The step ladder as defined in claim 8, wherein each brace of each of the first pair of braces and the second pair of braces has a detachable end with a projecting pin that supports a cantilevered engagement member, the cantilevered engagement member being received in a pocket, the pocket having a vertical slot to accommodate the projecting pin.
